(19) United States
(12) Patent Application Publication
(10) Pub. No.: US 2009/0317056 A1
(43) Pub. Date: Dec. 24, 2009

(54) SYSTEM AND METHOD FOR MANAGING SCHEDULES OF MONITORING DEVICE

(75) Inventors: Hao Hu, Pudong District (CN); Hideo Miyamaki, Pudong District (CN); Satoshi Ishii, Tokyo (JP); Shin Yanai, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sony Corporation, Tokyo (JP)

(21) Appl. No.: 12/483,559

(22) Filed: Jun. 12, 2009

(30) Foreign Application Priority Data
Jun. 13, 2008 (CN) 200810111292.0

(51) Int. Cl. H04N 5/91

(52) U.S. Cl. 386/83; 386/117; 386/E05.003

(57) ABSTRACT

A method for managing schedules of a monitoring device includes: editing schedules of a video camera; generating a display interface on which a plurality of schedules and corresponding attributes thereof can be displayed; checking the realizability of the schedules; and generating conflict indicating information for conflicting schedules according to a checking result. The present invention further provides a system for managing schedules of a monitoring device. The invention can be applied to display the schedules of the monitoring device intuitively and clearly to thereby simplify operations of determining a conflict and optimize operations of editing the schedules.

### FIELD OF THE INVENTION

The present invention relates to a system and method for managing schedules of a monitoring device.

### BACKGROUND OF THE INVENTION

An information transmission manner for a traditional monitoring system is an analog manner in which an image is transferred to a monitor over a coaxial cable in a baseband transmission manner and disadvantages of which include a short transmission range, complex wiring, etc. Consequently, analog monitoring manner can not meet a demand for monitoring over a large range and over a long distance in some industries, for example, city security monitoring, traffic monitoring, banking monitoring, etc.

Remote network monitoring has spread over numerous fields of education, governments, entertainment sites, hospitals, hotels, sports centers, city securities, etc., along with widespread popularization of communication networks. In FIG. 1, an existing network monitoring system 1 includes a plurality of remote video cameras 10, one or more servers 12 connected with the video cameras 10 over a network, and one or more clients 14 for controlling the server(s) 12. In FIG. 2, another existing network monitoring system 2 includes a plurality of remote video cameras 20 and one or more servers 22 connected with the video cameras 20 and for controlling the video cameras 20 over a network. The video cameras 10(20) collect and compress images and transfers the images to the server(s) 12(22) over the network for decompression and display.

In a remote network monitoring system, it is possible to edit in advance an action schedule of a video camera or a recording schedule of a video recorder in a server, and the remote network monitoring system can operate automatically according to the action schedule and/or the recording schedule during remote network monitoring.

However in the prior art, if a plurality of video cameras with different setting conditions are present in a network monitoring system, then it is typical during schedule edition that a recording schedule (at the server end) and an action schedule (at the video camera end) are edited via different interfaces and even the different video cameras are provided with different interfaces, so that a plurality of schedules can not be displayed on the same interface and thus may appear disordered; and when it is required to edit or view the respective schedules, the respective corresponding editing interfaces have to be opened respectively, which may be troublesome. Furthermore, such a display manner may cause the absence of an association between the schedules displayed on the respective editing interfaces and thus can not avoid a conflict, for example, a time conflict, a priority conflict, a preset dynamic perception type conflict between a recording schedule and an action schedule. A user has to open the editing interfaces corresponding to the respective schedules respectively and then to compare the schedules therein respectively and determine whether a conflict is present therebetween in order to find a conflict which may involve cumbersome operations that are time-consuming and error-prone. For example, for a schedule which is intended to be edited preferentially and which may bring an influence upon other schedules, it has been very difficult to ensure editing of the schedule in question while implementing editing of the other schedules with a tradeoff.

### SUMMARY OF THE INVENTION

The invention provides a system and method for managing schedules of a monitoring device to simplify operations of determining a conflict and to optimize operations of editing the schedules.

An aspect of the invention provides a system for managing schedules of a monitoring device, which includes: a schedule editing unit adapted to edit the schedules of the monitoring device, the schedules each including attributes of a schedule type, a working day, and starting and ending times, the schedule type including a recording schedule of a video recorder and an action schedule of a video camera; an interface generating unit adapted to generate a display interface according to the schedules edited by the schedule editing unit, wherein a plurality of schedules and corresponding attributes thereof can be displayed on the same display interface; a schedule checking unit adapted to check realizability of the schedules edited by the schedule editing unit; and a conflict indicating unit adapted to generate conflict indicating information for conflicting schedules according to a checking result of the schedule checking unit.

Optionally, the system further includes a schedule grouping unit adapted to group the plurality of schedules edited by the schedule editing unit according to the attributes of the schedules to form a plurality of groups of schedules with the same attributes.

Optionally, the system further includes a database adapted to store the schedules and their editing results.

Optionally, the schedule editing unit further includes a recording schedule editing sub-unit adapted to edit the recording schedule and an action schedule editing sub-unit adapted to edit the action schedule.

Optionally, the display interface generated by the interface generating unit displays the respective schedules in a graphic or tabular form.

Optionally, the action schedule includes a moving speed, a moving manner or a moving scope of an angle of the video camera, and the recording schedule of the video recorder has a higher priority than the action schedule of the video camera.

Optionally, the attributes of the schedules further include a triggering type and a dynamic perception type.

Optionally, the dynamic perception type includes a video camera dynamic perception type, a mode where the video camera filters a moving object and a video recorder dynamic perception type.

Optionally, the conflict includes a time conflict or a dynamic perception type conflict between the schedules.

Optionally, the dynamic perception type conflict refers to: both the video camera dynamic perception type and the mode where the video camera filters a moving object are set simultaneously.

Optionally, the conflict indicating information includes a form of highlight, color, text, icon or sound to indicate the conflicting schedules.

Another aspect of the invention provides a method for managing schedules of a monitoring device, which includes: editing the schedules of the monitoring device, the schedules each including attributes of a schedule type, a working day, and starting and ending times, the schedule type including a recording schedule of a video recorder and an action schedule of a video camera; generating a display interface according to an editing result, in which a plurality of the schedules and their corresponding attributes can be displayed on the same display interface; checking realizability of the edited schedules; and generating conflict indicating information for conflicting schedules according to a checking result.

Optionally, the method further includes grouping the plurality of schedules according to the attributes of the schedules to form a plurality of groups of schedules with the same attributes.

Optionally, the action schedule includes a moving speed, a moving manner or a moving scope of an angle of the video camera, and the recording schedule of the video recorder has a higher priority than the action schedule of the video camera.

Optionally, the attributes of the schedules further include a triggering type and a dynamic perception type.

Optionally, the dynamic perception type includes a video camera dynamic perception type, a mode where the video camera filters a moving object and a video recorder dynamic perception type.

Optionally, the conflict includes a time conflict or a dynamic perception type conflict between the schedules.

Optionally, the dynamic perception type conflict refers to: both the video camera dynamic perception type and the mode where the video camera filters a moving object are set simultaneously.

Optionally, the conflict indicating information includes a form of highlight, color, text, icon or sound to indicate the conflicting schedules.

As compared with the prior art, the invention provides a system and method for managing schedules of a monitoring device in which schedules are edited for the monitoring device and a plurality of schedules together with corresponding attributes thereof are displayed on a generated display interface, the realizability of the schedules is checked, and conflict indicating information is generated for conflicting schedules according to a checking result. The invention can display the respective schedules and their attributes intuitively on the display interface to thereby simplify operations of determining a conflict and optimize operations of editing the schedules.

### BRIEF DESCRIPTION OF THE DRAWINGS

FIG. 1 is a schematic structural diagram of a network monitoring system;

FIG. 2 is another schematic structural diagram of a network monitoring system;

FIG. 3 is a schematic structural diagram of a system for managing schedules of a monitoring device according to an embodiment of the invention;

FIG. 4 is another schematic structural diagram of a system for managing schedules of a monitoring device according to an embodiment of the invention;

FIG. 5 is a schematic diagram of a graphic interface for displaying a plurality of schedules according to an embodiment of the invention;

FIG. 6 is a schematic flow chart of a method for managing schedules of a monitoring device according to an embodiment of the invention; and

FIG. 7 is another schematic flow chart of a method for managing schedules of a monitoring device according to an embodiment of the invention.

### DETAILED DESCRIPTION OF THE INVENTION

Embodiments of the invention provide a system and method for managing schedules of a monitoring device in which schedules are edited for the monitoring device and a plurality of schedules together with corresponding attributes thereof are displayed intuitively and clearly on a generated display interface, the realizability of the schedules is checked, and conflict indicating information is generated for conflicting schedules according to a checking result, thereby simplifying operations of determining a conflict and optimizing operations of editing the schedules. Detailed descriptions will be presented below in connection with the drawings and the embodiments.

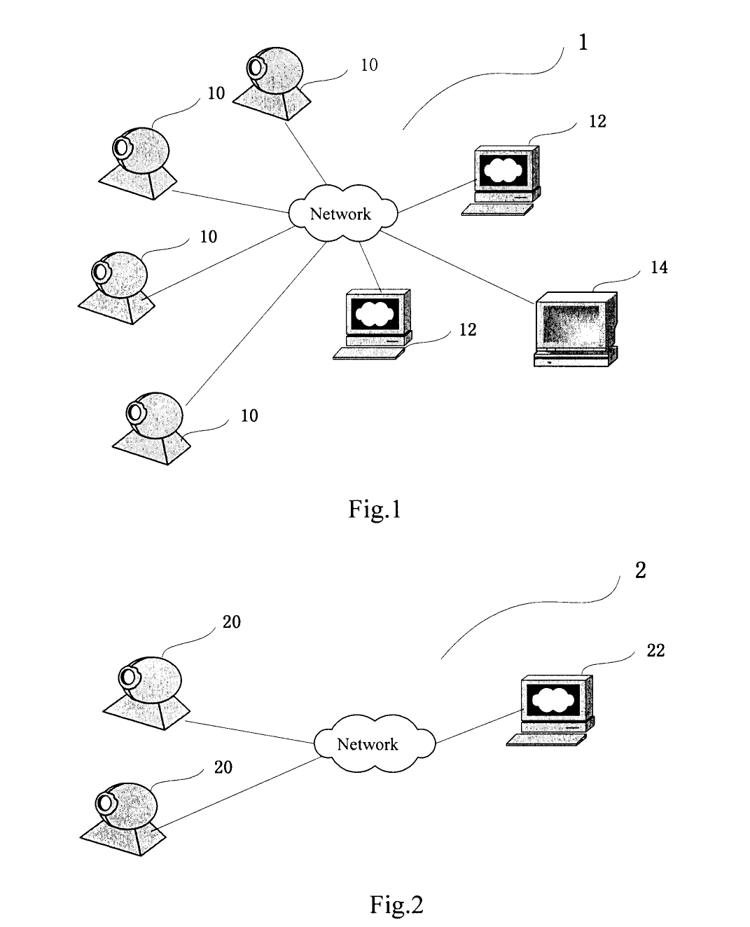

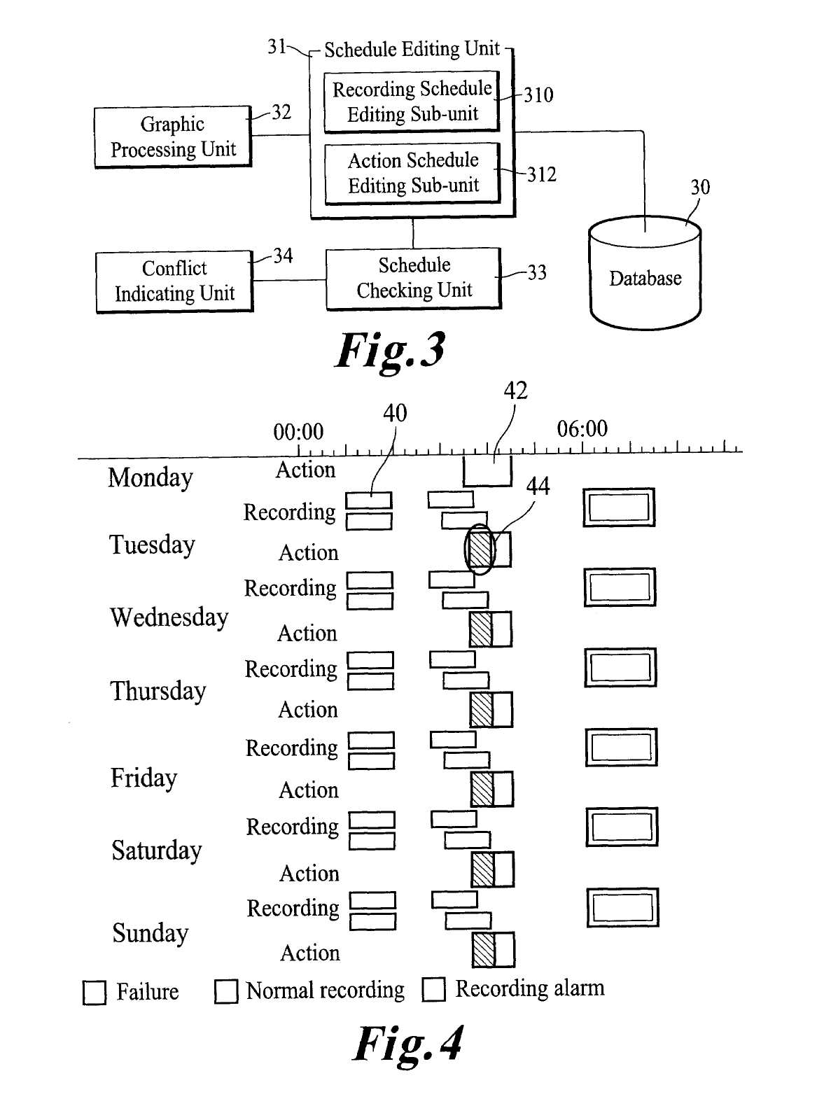

FIG. 3 is a schematic structural diagram of a system for managing schedules of a monitoring device according to an embodiment of the invention, and in the present embodiment, the system for managing schedules of a monitoring device is built in the server 12(22) of the network monitoring system 1(2) illustrated in FIG. 1 or FIG. 2, and the schedules of the monitoring device are managed at the server 12(22) end. As illustrated in FIG. 3, the system for managing schedules of a monitoring device 3 includes a schedule editing unit 31, an interface generating unit 32, a schedule checking unit 33 and a conflict indicating unit 34.

The schedule editing unit 31 is adapted to edit the schedules of the monitoring device. In the present embodiment, the monitoring device includes a video recorder and a video camera in the server. The schedules include a plurality of attributes, for example, of a schedule type, a working day, starting and ending times, a triggering type, a dynamic perception type, etc. Specifically, the schedule type includes a recording schedule of the video recorder and an action schedule of the video camera. The recording schedule refers to a schedule of performing video recording in the case that the starting time, the ending times and a triggering condition (optional) are given. The action schedule refers to a schedule of controlling the video camera in the case that the starting time, the ending times, a triggering condition and an action setting are given, and the action setting includes a setting of a moving speed, a moving manner or a moving scope of an angle of the video camera. The recording schedule of the video recorder has a higher priority than that of the action scheduling of the video camera.

Furthermore, the dynamic perception type includes a video camera dynamic perception type, a mode in which the video camera filters a moving object and a video recorder dynamic perception type. The video camera dynamic perception type and the video recorder dynamic perception type include determining whether a moving object occurs within a certain region of an image, for example, by mathematic calculations. In addition to determining whether a moving object occurs within the region, the mode in which the video camera filters a moving object further includes detecting and recording a trajectory along which the moving object is moving and coordinates of the moving object in the image.

Furthermore, the triggering condition can be set depending upon the different dynamic perception type so as to trigger executing of a schedule when the triggering condition is satisfied. The dynamic perception function and the moving object filtering mode are different in that the former only stores in a video a region and a detection result, that is, a Boolean value of whether an object occurs and the latter stores all regions which are set and coordinates of a detected object. Different filtering conditions can be set with the information stored by the latter during searching of a video.

In the system for managing schedules of a monitoring device according to the embodiment of the invention, the schedule editing module 31 further includes a recording schedule editing sub-unit 310 and an action schedule editing sub-unit 312. The recording schedule editing sub-unit 310 is adapted to edit the recording schedule, where the editing includes setting a schedule name, a time, a type, a triggering condition, and to add or delete the schedule as appropriate. The action schedule editing sub-unit 312 is adapted to edit the action schedule, where the action editing includes setting an action parameter of the video camera according to an action of the video camera, setting an action parameter of the system according to the operation of the system, and setting a local action parameter according to a local action.

The interface generating unit 32 is adapted to generate a display interface according to the schedules edited by the schedule editing unit 31, and a plurality of schedules and corresponding attributes thereof can be displayed on the same display interface. In the present embodiment, the display interface generated by the interface generating unit 32 includes displaying the plurality of schedules in a graphic form but will not be limited thereto, and the display interface can alternatively be displayed in a tabular form. Specifically, the interface generation unit 32 reads the attributes of a schedule type, a working day, starting and ending times, a triggering type, a dynamic perception type, etc., of the respective schedules, and displays the schedules in the form of a time bar according to the attributes, where the boundaries of the time bar indicate starting and ending times of the schedule respectively, and the length of the time bar indicates a duration of executing the schedule. In the present embodiment, the time of the schedule can be varied by moving the time bar, for example, the starting or ending time of the schedule can be varied by dragging the left or right boundary of the time bar, or the duration of the schedule can be varied by dragging the two boundaries of the time bar to varying the length of the time bar. Furthermore, the schedules of different types can be represented respectively, for example, with time bars of different forms. For example, the recording schedule of the video recorder is represented with a thin time bar, and the action schedule of the video camera is represented with a wide time bar.

FIG. 4 illustrates a schematic diagram of a graphic interface displayed by the interface generation unit 32 in a graphic form after graphic processing of the respective schedules in an embodiment of the invention. As illustrated in FIG. 4, recording schedules of the video recorder (a thin bar 40) and action schedules of the video camera (a wide bar 42) are displayed in the form of time bars by seven working days per week within two segments. With the processing by the interface generation unit 32, the respective attributes of the schedules can be displayed in a graphic form concisely, conveniently, and clearly. The foregoing is merely exemplary, but the invention will not be limited thereto. The form of a time bar will not be limited thereto as long as schedules of different types can be distinguished clearly. For example, the recording schedule of the video recorder can still be represented with a time bar with slope lines, and the action schedule of the video camera can be represented with a time bar with asterisks. Furthermore, for a display interface capable of displaying colors, schedule of different types can be represented respectively with time bars with different colors. Of course, the above respective display methods can be adopted individually or in combination to provide different modifications, repeated descriptions of which will be omitted here.

The schedule checking unit 33 is adapted to check the realizability of the schedules edited by the schedule editing unit 31. In the present embodiment, the schedule checking unit 33 checks whether a conflict is present between the respective schedules according to the attributes of a schedule type, a working day, starting and ending times, a triggering type, a dynamic perception type, etc., of the respective schedules. The conflict includes a time conflict or a dynamic perception type conflict, where the time conflict refers to a time coincidence of the recording schedule of the video recorder and the action schedule of the video camera, and the dynamic perception type conflict refers to that both the video camera dynamic perception type and the mode in which the video camera filters a moving object are set simultaneously so that the video camera can not enable the two different perception types at the same time. Furthermore, the recording setting of the video camera may also result in a case that the dynamic perception function of the video camera is limited and even unavailable. For example, in the case that recording with H264 coding is set as well or the use of Dual Codec for both monitoring and recording is set, no dynamic perception function of the video camera will be available because a great deal of memory and the chip occupancy ratio of the video camera, which are very limited in the video camera, will be consumed for the dynamic perception function.

The conflict indicating unit 34 is adapted to generate the conflict indicating information for conflicting schedules according to a checking result of the schedule checking unit 33. In other words, when the checking result obtained after being checked by the schedule checking unit 33 indicates presence of the conflicting schedules, the conflict indicating unit 34 generates the conflict indicating information and displays the conflict indicating information on the display interface generated by the interface generation unit 32 to indicate to the user the schedule names, the conflict type, the time region corresponding to the conflict, etc., of the conflicting schedules. The conflict indicating information includes forms of highlight, color, text, icon, sound, etc., to indicate the conflicting schedules. For example, as illustrated in FIG. 4, the recording schedule of the video recorder and the action schedule of the video camera with a time conflict can be indicated in a highlighting and sparkling form on the time bar 44 of mutually coinciding time segments, or those with a dynamic perception type conflict can be indicated on the time bar 44 corresponding to the conflicting video camera dynamic perception function. Thus, the conflicting schedules can be known rapidly and accurately from the conflict indicating information to thereby simplify operations of determining a conflict as compared with the operations in the prior art of opening the editing interfaces corresponding to the respective schedules respectively and comparing the schedules therein respectively to determine whether a conflict is present therebetween. The schedule editing unit 31 is enabled according to the checking result of the schedule checking unit 33. Thus, the schedule editing unit 31 is invoked in subsequent operations to modify the conflicting schedules to address the conflict. In the present embodiment, an editing page corresponding to the schedule editing unit 31 can be popped up directly, for example, by clicking the conflicting schedules, and the conflicting attributes (the starting and ending times or the dynamic perception type) can be modified in the editing page. Specifically for a time conflict, the conflict can be avoided by modifying in the editing page the starting and ending times of the conflicting schedules. For a dynamic perception type conflict, the video camera dynamic perception type and the mode in which the video camera filters a moving object can not be available simultaneously, and at this time the triggering condition of the video camera dynamic perception type can be replaced with the video recorder dynamic perception type, so that the same logic setting as the video camera dynamic perception type can be used for the video recorder dynamic perception type, thereby satisfying the condition without any conflict. Furthermore, the conflicting schedules after being modified by invoking the schedule editing unit 31 can be marked with a “Modified” flag and then be stored, so that the user can be aware of that the schedules are in a status of being modified.

It shall be further noted that it is also practically possible to perform on the interface generation unit 32 operations of varying the time of a schedule directly by moving a time bar (for example, varying a starting or ending time of the schedule by dragging the left or right boundary of the time bar), of varying a duration of the schedule, etc., to achieve the same effect as the above schedule editing unit 31.

As illustrated in FIG. 3, the system for managing schedules of a monitoring device according to an embodiment of the invention further includes a database 30 adapted to store, for example, the edited or modified schedules. In the present embodiment, the database 30 can be a hard disk, a storage device or a magnetic disk of the server(s) 12(22).

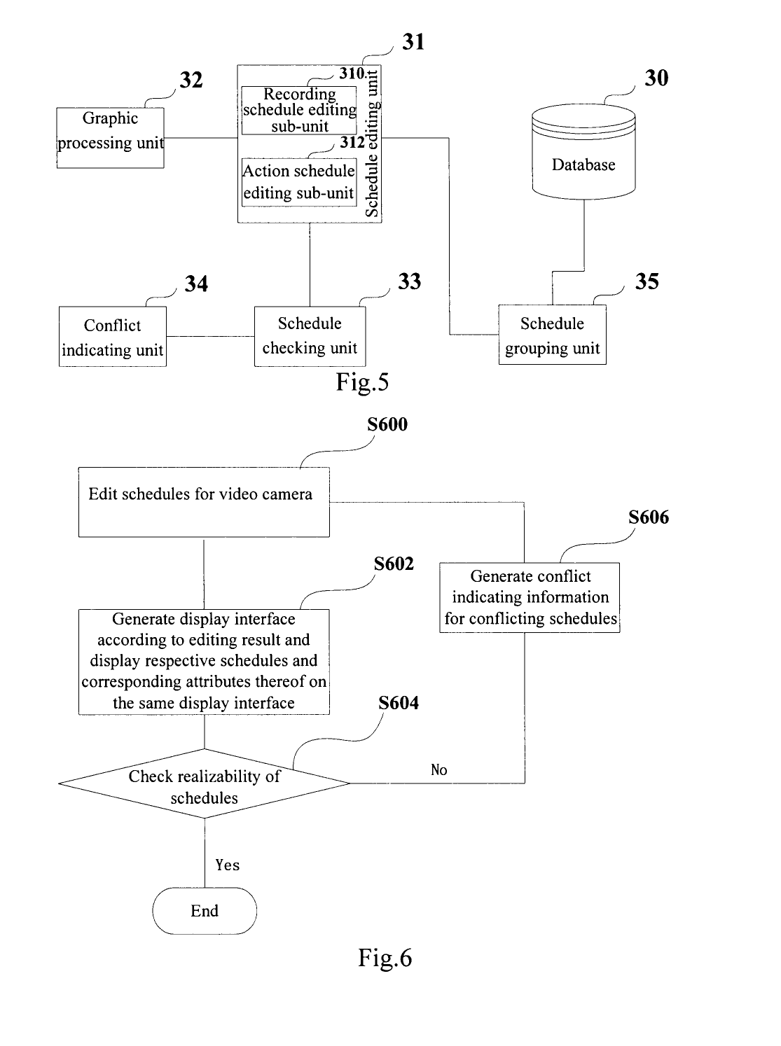

As illustrated in FIG. 5, the system for managing schedules of a monitoring device according to another embodiment of the invention further includes a schedule grouping unit 35 adapted to group a plurality of schedules edited by the schedule editing unit 31 according to the attributes of the schedules to form a plurality of groups of schedules with the same attributes, and to store the plurality of groups of schedules in the database 30.

Specifically, the grouping unit 35 groups the schedules with the same schedule type, working day, starting and ending times, triggering type and dynamic perception type into a group. For example, the recording schedules of all the video recorders can be grouped according to the working day, the starting and ending times, the triggering type and the dynamic perception type, or the action schedules of all the video cameras can be grouped according to the working day, the starting and ending time and the dynamic perception type. Thus, the grouping of the schedules by the schedule grouping unit 35 can make the plurality of schedules be sorted according to the attributes, that is, an operation performed on a group of schedules will be applied to execution of the schedules of all the video cameras in the group of schedules without performing the operation on every video cameras respectively, thereby improving relatively the efficiency of the operation. Furthermore, the schedule grouping strategy can achieve a more significant effect of improving the efficiency for a larger number of video cameras involved in the system for managing schedules of a monitor device.

It shall be further noted that a group of schedules made by the schedule grouping unit 35 include one or possibly more schedules with the same attribute, but, a time bar of only one of the schedules, for example, will be used to represent all the schedules in the group of schedules including that schedule when they are displayed in a graphic form on the display interface generated by the interface generation unit 32. As such, a display space of the schedules can be saved relatively, and it is possible to display a large number of schedules or even all the schedules (or groups of schedules) on the same interface, thereby improving greatly the display effect, viewing the schedules conveniently and facilitating subsequent checking and modifying of the schedules.

It shall be noted that the system for managing schedules of a monitoring device according to the embodiment of the invention is built in the server 12(22), which includes the video recorder, of the network monitoring system 1(2) illustrated in FIG. 1 or FIG. 2 as mentioned above, but the invention will not be limited thereto. In fact, the invention can be extended otherwise, for example, the system for managing schedules of a monitoring system can alternatively be built in the client 14, which includes the video recorder, of the network monitoring system 1(2) illustrated in FIG. 1.

Corresponding to the system for managing schedules of a monitoring device illustrated in FIG. 3 or FIG. 5 in the aforementioned embodiments, the invention further provide a method for managing schedules of a monitoring device. FIG. 6 is a schematic flow chart illustrating a method for managing schedules of a monitoring device according to an embodiment of the invention. The method includes the following steps, and firstly the step S600 is performed.

In the step S600, schedules including a plurality of attributes of a schedule type, a working day, starting and ending times, a triggering type, a dynamic perception type, etc., are edited for a video camera. In the present embodiment, the respective attributes of the schedules are set in an editing page. The schedule type includes a recording schedule of a video camera and an action schedule of the video camera. The dynamic perception type includes a video camera dynamic perception type, a mode in which the video camera filters a moving object and a video recorder dynamic perception type. Here, if the schedule type is the recording schedule of the video recorder, then the editing of the recording schedule includes setting a schedule name, a time, a type, a triggering condition, etc., and adding or deleting the schedule as appropriate; and if the schedule type is the action schedule of the video camera, then the editing of the action schedule includes setting an action parameter of the video camera according to an action of the video camera, setting an action parameter of the system according to the operation of the system, and setting a local action parameter according to a local action. Next, the step S602 is performed.

In the step S602, a display interface on which a plurality of schedules and corresponding attributes thereof can be displayed is generated according to the editing result. In the present embodiment, a graphic display will be described as an example. Specifically, the attributes of a schedule type, a working day, starting and ending times, a triggering type, a dynamic perception type, etc., of the schedules are read, and the schedules are displayed in the form of a time bar, where the boundaries of the time bar indicate starting and ending times of the schedule respectively, and the length of the time bar indicates a duration of executing the schedule. Thus, the schedules in all the working days can be displayed in the graphic form concisely, conveniently and clearly. Next, the step S604 is performed.

In the step S604, the realizability of the schedules is checked, and in the present embodiment, it is checked whether a time conflict or a dynamic perception type conflict is present between the respective schedules. The time conflict refers to a time coincidence of the recording schedule of the video recorder and the action schedule of the video camera, and the dynamic perception type conflict refers to: both the video camera perception type and the mode in which the video camera filters a moving object are set so that the video camera can not enable the two different perception types at the same time. Next, the step S606 is performed.

In the step S606, conflict indicating information is generated for conflicting schedules according to a checking result of the step S604. In other words, when the checking result indicates presence of the conflicting schedules, the conflict indicating information is generated to indicate to the user the schedule names, the conflict type, the time region corresponding to the conflict, etc., of the conflicting schedules. The conflict indicating information includes forms of highlight, color, text, icon, sound, etc., to indicate the conflicting schedules. Thus, the conflicting schedules can be known rapidly and accurately from the conflict indicating information. The method for managing schedules of a monitoring device according to the invention further includes reediting the schedules of the monitoring device according to the checking result. Then the operations in the step S600 are executed to invoke the editing page in which the conflicting attributes in the settings of the original schedules are reedited or modified to avoid the conflict.

The method for managing schedules of a monitoring device according to the invention further includes performs again the steps of checking a conflict, etc., on the reedited conflicting schedules or an added additional schedule. The steps of checking a conflict, etc., have been described as above, and repeated descriptions thereof will be omitted here.

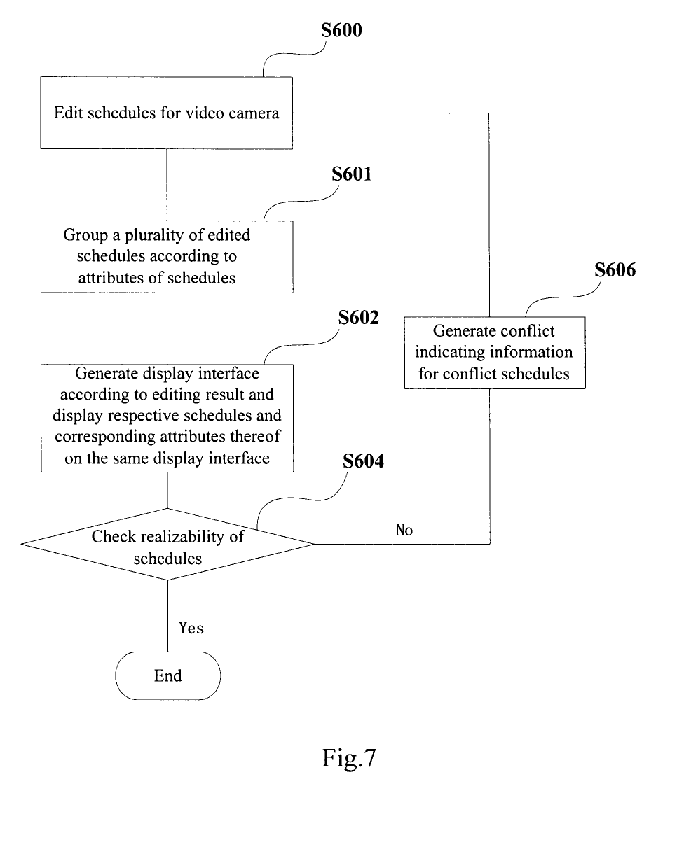

The foregoing descriptions are merely illustrative of one of embodiments of the method for managing schedules of a monitoring device according to the invention but not limitative of the scope in which the invention is applicable. In another embodiment of the invention, for example, as illustrated in FIG. 7, a step S601 of grouping the schedules can further be included between the steps S600 and S602. That is, in the step S601, the plurality of schedules edited in the step S600 are grouped according to the attributes of the schedules to form a plurality of groups of schedules with the same attributes, and the plurality of groups of schedules are stored. Specifically, the schedules with the same schedule type, working day, starting and end times, triggering type and dynamic perception type can be grouped into a group. For example, the recording schedules of all the video recorders can be grouped according to the working day, the starting and ending times and the dynamic perception type, or the action schedules of all the video cameras can be grouped according to the working day, the starting and ending times and the dynamic perception type.

As can be apparent from the above, the grouping can make the plurality of schedules be sorted into the groups of schedules according to the attributes, so that an operation performed on a group of schedules will be applied to the schedules of all the video cameras in the group of schedules without performing the operation on every video cameras respectively, thereby improving relatively the efficiency of the operation. Furthermore, for addition or deletion of a schedule as appropriate, in an example of adding a schedule, a video camera to be added can be simply designated to a certain group of schedules, so that the schedule to be added can provided with the attributes of a working day, starting and ending times, a triggering type, a dynamic perception type, etc., of the group of schedules without setting the respective attributes respectively, thereby greatly simplifying the operations and improving the operation efficiency as compared with the prior art or a case of no grouping of the schedules. Furthermore, particularly for the group of schedules resulting from the grouping, a time bar of only one of the schedules, for example, will be used on the display interface generated in the subsequent step S602 to represent all the schedules in the group of schedules including that schedule, the respective schedules can be managed effectively, and as many of the respective schedules as possible can be displayed in the same interface concisely and clearly to facilitate management of a plurality of schedules.

In summary, the system and method for managing schedules of a monitoring device according to the invention as compared with the prior art can edit the schedules of the video camera, display the respective schedules in a graphic form and modify the conflicting schedules to avoid a conflict. The invention can not only display the schedules of the monitoring device in the graphic form to provide the user with an intuitive and clear knowledge of the schedules but also determine easily the time range of the conflict and the priority sequence of the schedules to thereby simplify the operations of determining a conflict and optimize the operations of editing the schedules.

Furthermore, according to the foregoing embodiments, the schedules can be set directly according to a limiting condition of the video camera which is output in advance to make the operations simple and the efficiency high relative to the prior art.

Although the invention has been disclosed as above in the preferred embodiments thereof, they are not intended to limit the invention. Any skilled in the art can make possible variations and modifications without departing from the spirit and scope of the invention, and therefore the claimed scope of the invention shall be as defined in the claims appended to the invention.

What is claimed is:

1. A system for managing schedules of a monitoring device, comprising:
a schedule editing unit adapted to edit the schedules of the monitoring device, the schedules each comprising attributes of a schedule type, a working day, and starting and ending times, the schedule type comprising a recording schedule of a video recorder and an action schedule of a video camera;
an interface generating unit adapted to generate a display interface according to the schedules edited by the schedule editing unit, wherein a plurality of schedules and corresponding attributes thereof can be displayed on the same display interface;
a schedule checking unit adapted to check realizability of the schedules edited by the schedule editing unit; and
a conflict indicating unit adapted to generate conflict indicating information for conflicting schedules according to a checking result of the schedule checking unit.

2. The system for managing schedules of a monitoring device according to claim 1, further comprising a schedule grouping unit adapted to group the plurality of schedules edited by the schedule editing unit according to the attributes of the schedules to form a plurality of groups of schedules with the same attributes.

3. The system for managing schedules of a monitoring device according to claim 1, further comprising a database adapted to store the schedules and their editing results.

4. The system for managing schedules of a monitoring device according to claim 1, wherein the schedule editing unit further comprises a recording schedule editing sub-unit adapted to edit the recording schedule and an action schedule editing sub-unit adapted to edit the action schedule.

5. The system for managing schedules of a monitoring device according to claim 1, wherein the display interface generated by the interface generating unit displays the respective schedules in a graphic or tabular form.

6. The system for managing schedules of a monitoring device according to claim 1, wherein the action schedule comprises a moving speed, a moving manner or a moving scope of an angle of the video camera, and the recording schedule of the video recorder has a higher priority than the action schedule of the video camera.

7. The system for managing schedules of a monitoring device according to claim 1, wherein the attributes of the schedules further comprise a triggering type and a dynamic perception type.

8. The system for managing schedules of a monitoring device according to claim 7, wherein the dynamic perception type comprises a video camera dynamic perception type, a mode where the video camera filters a moving object and a video recorder dynamic perception type.

9. The system for managing schedules of a monitoring device according to claim 8, wherein the conflict comprises a time conflict or a dynamic perception type conflict between the schedules.

10. The system for managing schedules of a monitoring device according to claim 9, wherein the dynamic perception type conflict refers to: both the video camera dynamic perception type and the mode where the video camera filters a moving object are set simultaneously.

11. The system for managing schedules of a monitoring device according to claim 1, wherein the conflict indicating information comprises a form of highlight, color, text, icon or sound to indicate the conflicting schedules.

12. The system for managing schedules of a monitoring device according to claim 1, wherein the schedule editing unit is enabled according to the checking result of the schedule checking unit.

13. A method for managing schedules of a monitoring device, comprising:
editing the schedules of the monitoring device, the schedules each comprising attributes of a schedule type, a working day, and starting and ending times, the schedule type comprising a recording schedule of a video recorder and an action schedule of a video camera;
generating a display interface according to an editing result, wherein a plurality of schedules and corresponding attributes thereof can be displayed on the same display interface;
checking realizability of the edited schedules; and
generating conflict indicating information for conflicting schedules according to a checking result.

14. The method for managing schedules of a monitoring device according to claim 13, further comprising grouping the plurality of schedules according to the attributes of the schedules to form a plurality of groups of schedules with the same attributes.

15. The method for managing schedules of a monitoring device according to claim 13, wherein the display interface displays the respective schedules in a graphic or tabular form.

16. The method for managing schedules of a monitoring device according to claim 13, wherein the action schedule comprises a moving speed, a moving manner or a moving scope of an angle of the video camera, and the recording schedule of the video recorder has a higher priority than the action schedule of the video camera.

17. The method for managing schedules of a monitoring device according to claim 13, wherein the attributes of the schedules further comprise a triggering type and a dynamic perception type.

18. The method for managing schedules of a monitoring device according to claim 17, wherein the dynamic perception type comprises a video camera dynamic perception type, a mode where the video camera filters a moving object and a video recorder dynamic perception type.

19. The method for managing schedules of a monitoring device according to claim 18, wherein the conflict comprises a time conflict or a dynamic perception type conflict between the schedules.

20. The method for managing schedules of a monitoring device according to claim 19, wherein the dynamic perception type conflict refers to: both the video camera dynamic perception type and the mode where the video camera filters a moving object are set simultaneously.

21. The method for managing schedules of a monitoring device according to claim 13, wherein the conflict indicating information comprises a form of highlight, color, text, icon or sound to indicate the conflicting schedules.

22. The method for managing schedules of a monitoring device according to claim 13, further comprising reediting the schedules of the monitoring device according to the checking result.
